(19) United States
(12) Patent Application Publication
(10) Pub. No.: US 2008/0091487 A1
(43) Pub. Date: Apr. 17, 2008

(54) APPARATUS AND METHOD FOR DERIVING ADVERTISING EXPENDITURE DATA

(75) Inventors: John Rodkin, San Francisco, CA (US); Leo Chang, San Carlos, CA (US); Sherrett Walker, San Francisco, CA (US)

Correspondence Address: MARGER JOHNSON & MCCOLLOM, P.C., 210 SW MORRISON STREET, SUITE 400, PORTLAND, OR, 97204, US

(73) Assignee: WEBTRENDS, INC., Portland, OR (US)

(21) Appl. No.: 11/867,624

(22) Filed: Oct. 4, 2007

Related U.S. Application Data
(60) Provisional application No. 60/828,370, filed on Oct. 5, 2006.

(51) Int. Cl. G06Q 10/00; G06F 17/00

(52) U.S. Cl. 705/7

(57) ABSTRACT

A method of evaluating advertising expenditures includes establishing a first relationship between advertising position and bid price. A second relationship between estimated expenditure per time period and bid price is formed. An average advertising position for an entity is observed. A frequency of appearance for the entity is located. The average advertising position is mapped to a bid price using the first relationship. The bid price is mapped to an estimated expenditure per time period using the second relationship. The average expenditure is multiplied by the frequency of appearance to establish a per time period expenditure for the entity.

### CROSS-REFERENCE TO RELATED APPLICATIONS

This application claims the benefit from U.S. Provisional Patent Application No. 60/828,370 filed Oct. 5, 2006 whose contents are incorporated herein for all purposes.

### BACKGROUND OF THE INVENTION

1. Field of the Invention

This invention relates generally to data processing. More particularly, this invention relates to techniques for deriving Internet-based advertising expenditures for specific entities.

2. Description of the Prior Art

It is difficult to derive reasonable estimates characterizing how much an entity spends on marketing related to Internet-based searching. Of particular interest is not only the market size (e.g., how many entities spend at least $X per month on Google and Yahoo?), but also market distribution (e.g., of those that do spend at least $X per month, how many are at the low-end of that range) and how this market is changing. Getting a list of the particular entities and estimates of how much they are currently spending on search advertising facilitates various marketing activities.

### SUMMARY OF THE INVENTION

A method of evaluating advertising expenditures includes establishing a first relationship between advertising position and bid price. A second relationship between estimated expenditure per time period and bid price is formed. An average advertising position for an entity is observed. A frequency of appearance for the entity is located. The average advertising position is mapped to a bid price using the first relationship. The bid price is mapped to an estimated expenditure per time period using the second relationship. The average expenditure is multiplied by the frequency of appearance to establish a per time period expenditure for the entity.

A computer readable storage medium, implementing the invention, comprises executable instructions to: query a search engine with a keyword to note an average position of an entity within the search engine results for the keyword; query a keyword estimate service of the search engine with a plurality of bid prices to establish a relationship between bid price and position; and map the average position against the relationship to obtain an estimated average daily spend to achieve that average position.

An apparatus for deriving advertising expenditure of an entity comprises a lead-generation robot configured to multiply query a search engine using a designated keyword and store in memory a position of an entity appearing within pages resulting from each of said queries. The apparatus further includes a keyword estimate service query engine configured to query a keyword estimate service of an Internet search engine using a plurality of bid prices to obtain an estimated position associated with each bid price. Finally, the apparatus further includes an advertising expenditure calculator operative to average the position of the entity across all queries by the lead-generation robot for the keyword, establish a relationship between bid price and position using data obtained by the keyword estimate service engine, and determine an estimate of the advertising expenditure of the entity responsive to an association of the average position with the relationship

### BRIEF DESCRIPTION OF THE DRAWINGS

The invention is more fully appreciated in connection with the following detailed description taken in conjunction with the accompanying drawings, in which:

FIG. 1 illustrates the invention implemented within a wide area network environment according to teachings of the invention.

FIG. 2 illustrates a computer configured in accordance with an embodiment of the invention to implement within the environment of FIG. 1.

FIG. 3 illustrates a method implemented by the computer of FIG. 2 according an embodiment of the invention,

FIG. 4 illustrates an exemplary search results page of a search service queried by the present invention.

FIGS. 5A-5C illustrate the results of three keyword search queries conducted according to the invention.

FIG. 6 illustrates an advertising position to bid price relationship utilized in accordance with an embodiment of the invention.

FIG. 7 illustrates an estimated expenditure per time period to bid price relationship utilized in accordance with an embodiment of the invention.

Like reference numerals refer to corresponding parts throughout the several views of the drawings.

### DETAILED DESCRIPTION

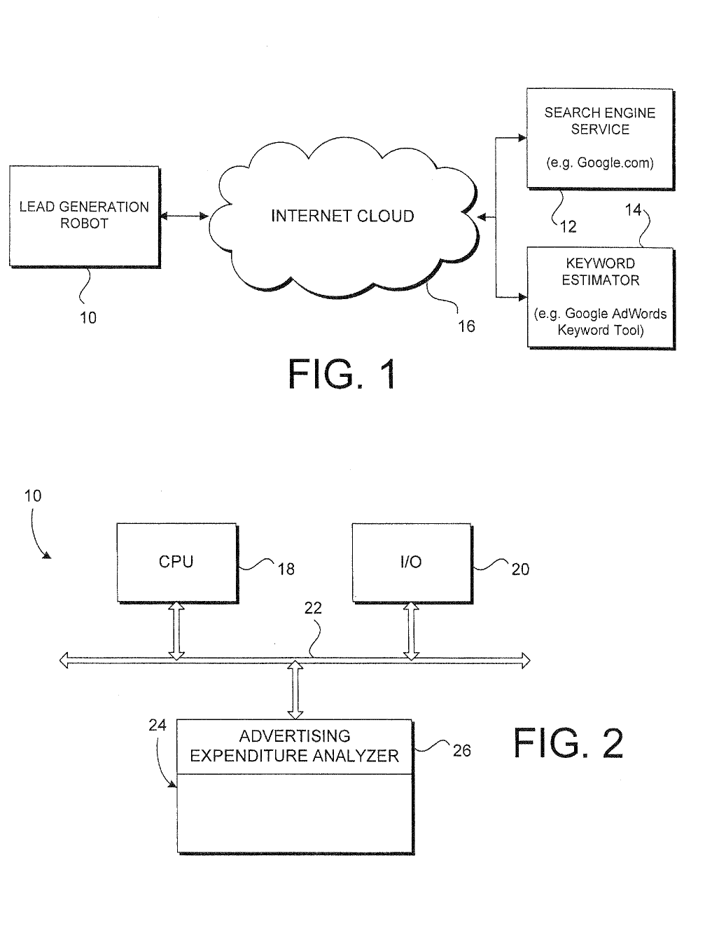

FIG. 1 illustrates a lead-generation robot 10 adapted to query both a search service 12 (e.g. google.com) and a keyword estimator 14 service of that search engine (e.g. Google's AdWords Keyword Tool) through a wide area network such as the Internet 16. As will be explained further below, the lead-generation robot 10 gathers two sets of data through its multiple queries: (a) the average ad position of a third party responsive to multiple keyword queries of the search engine 12, and (b) a relationship between bid price of the keyword and position through multiple bid queries of the keyword estimator 14. From this data, the lead generation robot can determine an average spend of a third party for their particular advertising campaign.

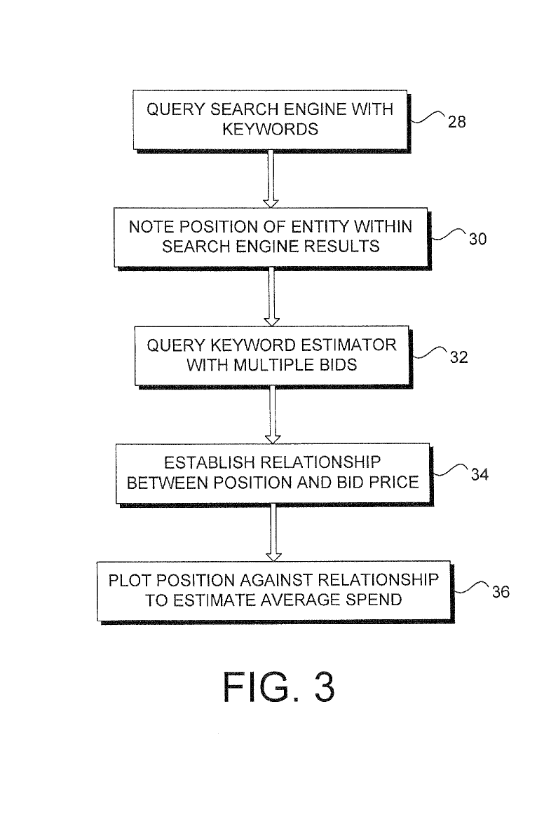

FIG. 2 illustrates a computer 10 configured in accordance with an embodiment of the invention. The computer 10 includes standard components, such as a central processing unit 18 and a set of input/output devices 20 connected via a bus 22. The input/output components may include a keyboard, mouse, display, printer, and the like. Also connected to the bus 22 is a memory 24.

The memory 24 stores executable instructions to implement operations of the invention. In particular, the memory 24 stores an advertising expenditure analyzer 26, which implements the operations discussed below.

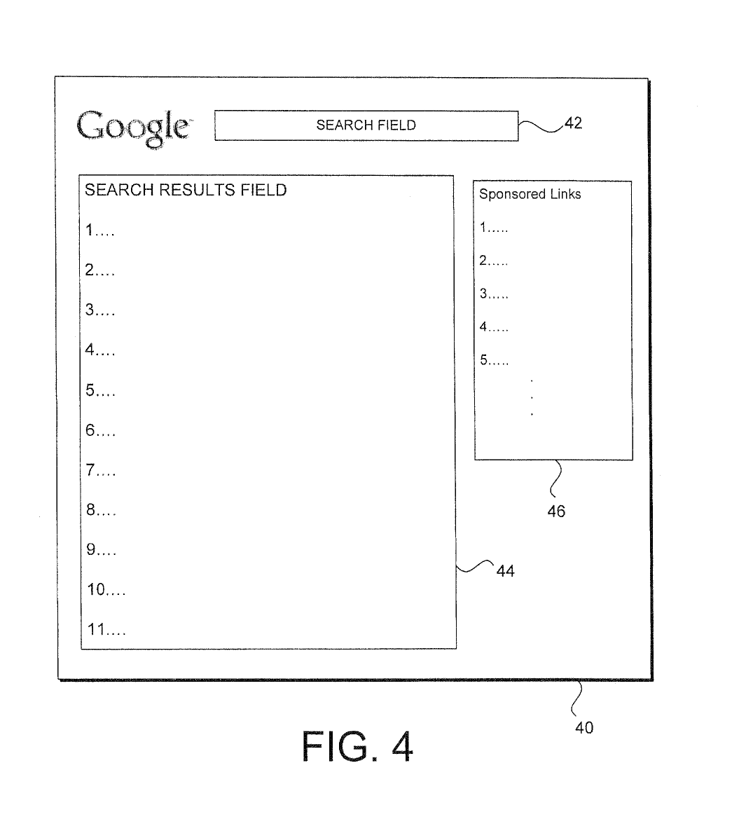

FIG. 3 illustrates the operation of the lead generation robot 10 of FIG. 2. In one embodiment of the invention, the lead-generation robot 10 uses keywords (e.g., aggregated across a variety of advertising campaigns) in block 28 and looks at the search results pages for these keywords from various search engines (e.g., Google and Yahoo) in block 30. The robot notes the advertisers on those pages, e.g. using the displayed domain under each advertisement on the page, and the position of each of those ads on the page averaged over impressions. How often the advertiser appears for that keyword is also tracked. The characteristics of this information (e.g. factors) are arranged in Table 1, below:

TABLE 1
Factors Gathered by Lead Generation Robot

| | | | |
|---|---|---|---|
| KEYWORD | ADVERTISER'S | AVERAGE | FREQUENCY OF |
| | DOMAIN | OBSERVED | APPEARANCE |
| | | POSITION | (FREQ) |
| | | (POS) | |

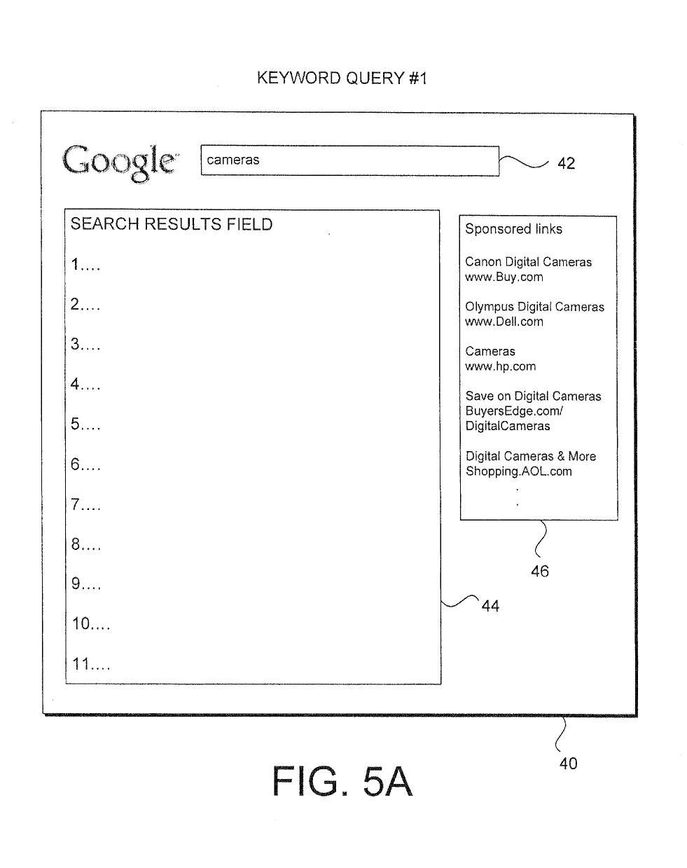

FIG. 4 illustrates a schematic of a Google® search results window 40 that may result from a typical search of the google.com search engine. The results window 40 includes a search filed 42 into which a user would input search terms, e.g. “keywords.” Searches would be conducted using the search engines proprietary systems and result in a list of the most relevant items displayed in a search results field 44 in order of relevance. To generate income, such search services also offer commercial organizations the opportunity to appear on these search results pages in a sponsored links portion 46 of the search results window 40. A common method for such search engines to trigger these paid listings is through keyword triggers—that is, third parties would bid for the right to appear on search result pages when certain words are entered in the search field 42. The order of such listings within the sponsored links field 46 is often determined by the amount of money paid by the party to be listed. The more money spent, the higher and more frequent the listing. Search engines such as google.com will often use algorithms to determine when such sponsors are listed, how often, and how high on the list.

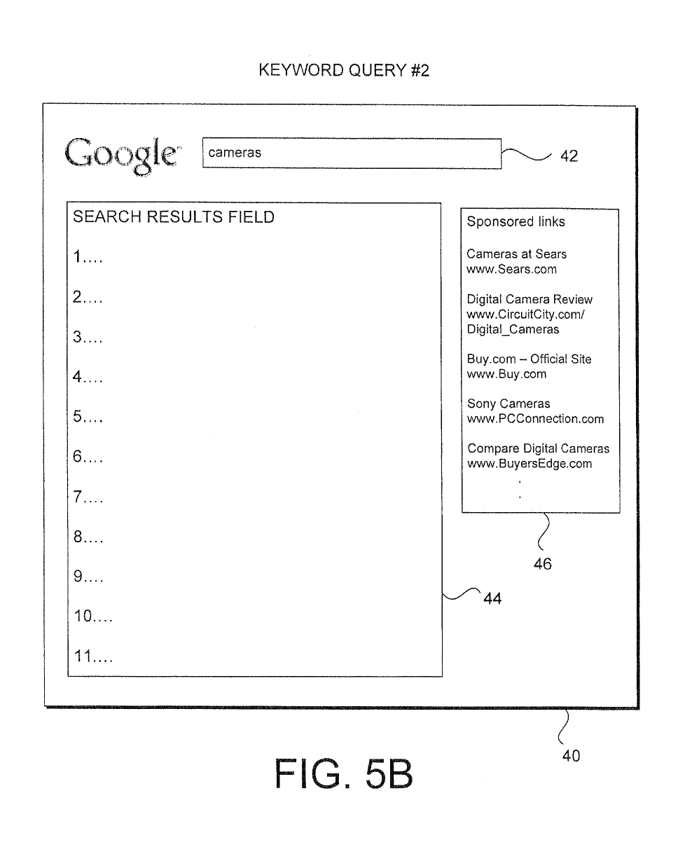

FIGS. 5A, 5B, and 5C illustrate examples of three queries of the Google® search engine for the same keyword. In this instance, the word “cameras” is input by lead generation robot 10 in the search field of the google.com web page and the sponsored links in field 46 observed. FIG. 5A illustrates the result of the first query by lead generation robot 10. FIG. 5B illustrates the result of the second query, and FIG. 5C illustrates the result of the third query. Table 2 below lists the first five sponsors observed from the three queries:

TABLE 2
Sponsor Position in Keyword Search for “cameras”

| POSI- | | | |
|---|---|---|---|
| TION | QUERY #1 | QUERY #2 | QUERY #3 |
| 1 | Buy.com | Sears | Kodak |
| 2 | Dell | Circuit City | Circuit City |
| 3 | HP | Buy.com | Buy.com |
| 4 | BuyersEdge.com | PCConnection.com | PCConnection.com |
| 5 | Shopping.AOL.com | BuyersEdge.com | BuyersEdge.com |

One notes that the same query can result in a very different list of sponsors. The top listed entity in each of the three queries is different: Buy.com, Sears, and Kodak. Furthermore, patterns of appearance emerge with more and more queries. For instance, Buy.com appears in all queries: in position #1 in the first query, and in position #3 in the second and third queries. BuyersEdge.com also appears in all queries, but at a lower position: in position #4 in the first query, and in position #5 in the second and third queries. The frequency of appearance for both Buy.com and BuyersEdge.com is thus high. Sears and Kodak, thought they appear at the top of one of the queries, do not appear in the top five list in the other queries. Their frequency of appearance is thus low.

A keyword estimate service (e.g., the Google service) is supplied with a keyword and a bid price in block 32. In return, the service supplies an estimated expenditure per time period (e.g., spend/day) as well as an average position in which an ad would appear. Alternate versions of the service might report a bid range for clicks per day and costs per click (as well as average position) from which the daily spend can be calculated. If one applies several different bids for a keyword, one can estimate a bid for any position using a method similar to linear interpolation in block 34.

TABLE 3
Factors Gathered from Keyword Estimate Service

| | | | |
|---|---|---|---|
| KEYWORD | BID | ESTIMATED | ESTIMATED |
| | PRICE | POSITION | DAILY SPEND |

By querying for several bid prices, one can interpolate the entire curve of Position to Bid price, as well as the curve of Bid price to Daily spend. With these two curves, one can, for each Domain, use POS to estimate Bid price, then use that Bid price to estimate Daily Spend (multiply the result by frequency).

By continuously updating this data and adding keywords to a database, one can improve the accuracy of data and see trends. In addition, one can identify entities that are good targets for marketing initiatives.

Consider the following example in which one is interested in the keyword “discount stuff.” The keyword estimate service may be queried with several bids:

TABLE 4
Sample Data from Keyword Estimate Service

| | BID | ESTIMATED | ESTIMATED |
|---|---|---|---|
| KEYWORD | PRICE | POSITION | DAILY SPEND |
| “discount | 0.50 | 8 | 25 |
| stuff” | 1.00 | 4.5 | 60 |
| | 2.00 | 2.2 | 100 |

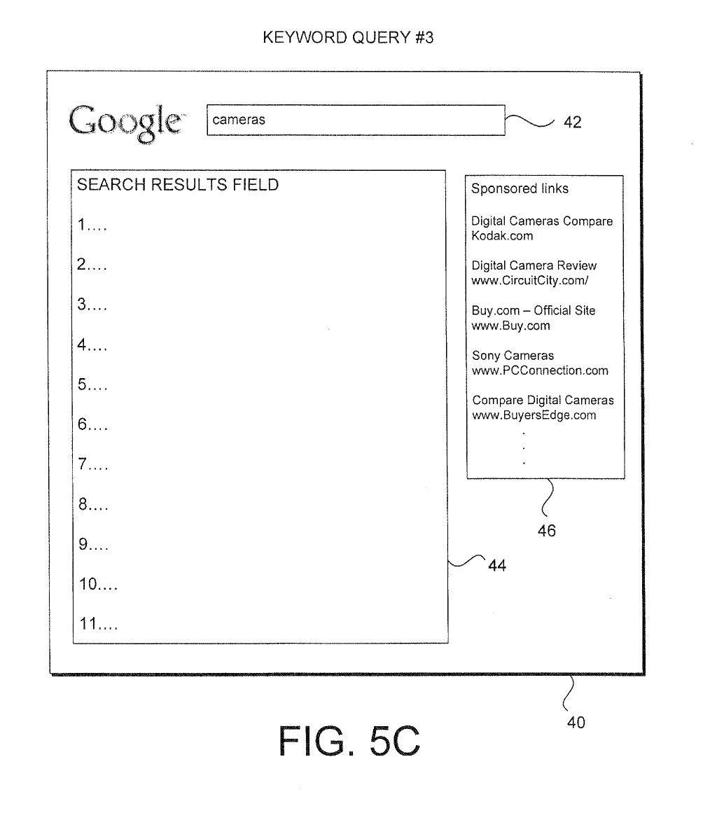

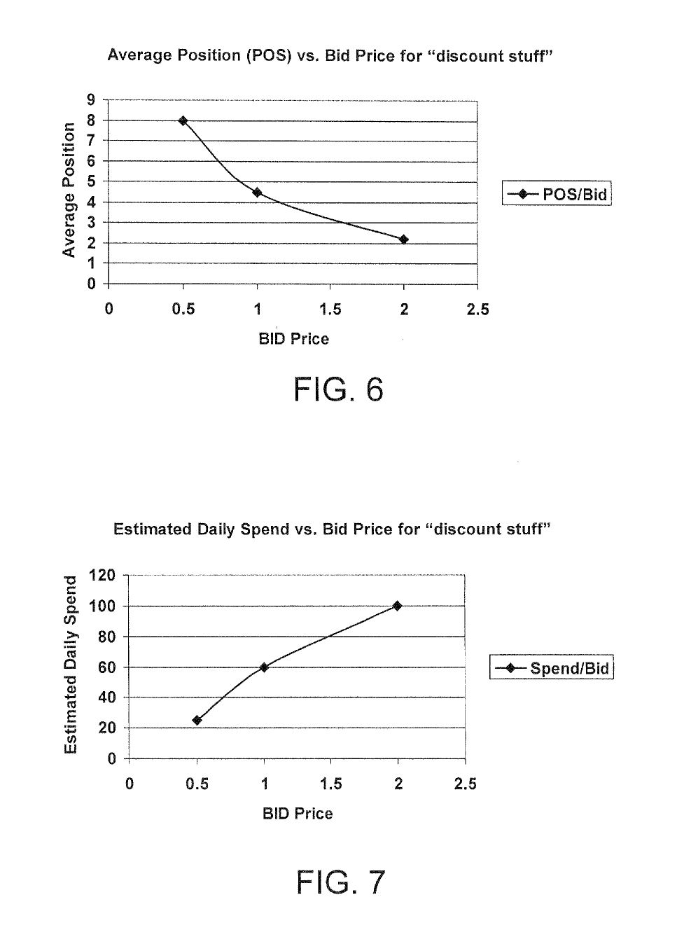

This information can be plotted as shown in FIG. 6 and FIG. 7. A robot then generates results from crawling “discount stuff”:

TABLE 5
Observed POS/FREQ for acme.com using
“discount stuff” keyword

| | | AVERAGE | |
|---|---|---|---|
| | | OBSERVED | FREQUENCY OF |
| | ADVERTISER'S | POSITION | APPEARANCE |
| KEYWORD | DOMAIN | (POS) | (FREQ) |
| “discount | www.acme.com | 3.2 | 75% |
| stuff” | | | |

Using the first curve of FIG. 6, an average position of 3.2 means a bid price of about 1.57. Using the second curve of FIG. 7, a bid price of 1.57 means an average daily spend of about 83. Using the frequency of 75%, one estimates that acme.com is spending about 62.25 on ads for the “discount stuff” keyword per day.

It is useful to keep track of the observed average position and frequency for each advertising network. An appropriate estimate service should be used for each advertising network. If only one estimate service is being used, one may assume the same market conditions and bid price curves for a different service.

An embodiment of the present invention relates to a computer storage product with a computer-readable medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs, DVDs and holographic devices; magneto-optical media; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hardwired circuitry in place of, or in combination with, machine-executable software instructions.

A computer readable storage medium, configured according to teachings of the present invention, comprises executable instructions to: query a search engine with a keyword to note an average position of an entity within the search engine results for the keyword; query a keyword estimate service of the search engine with a plurality of bid prices to establish a relationship between bid price and position; and map the average position against the relationship to obtain an estimated average daily spend to achieve that average position.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

Having described and illustrated the principles of the invention in a preferred embodiment thereof, it should be apparent that the invention can be modified in arrangement and detail without departing from such principles. We claim all modifications and variation coming within the spirit and scope of the following claims.

What is claimed is:

1. A method of evaluating advertising expenditures, comprising:
establishing a first relationship between advertising position and bid price;
forming a second relationship between estimated expenditure per time period and bid price;
observing an average advertising position for an entity;
locating a frequency of appearance for the entity;
mapping the average advertising position to a bid price using the first relationship and the bid price to an estimated expenditure per time period using the second relationship; and
multiplying the average expenditure by the frequency of appearance to establish a per time period expenditure for the entity.

2. The method of claim 1 further comprising generating a list of entities and corresponding per time period expenditures.

3. A method for evaluating advertising expenditures of an entity using keyword purchases on a search engine, the method comprising:
querying a keyword estimate service of the search engine with a plurality of bid prices for a target keyword to obtain a first relationship of advertising position to bid price for the search engine;
interpolating a curve using the first relationship;
robotically crawling the search engine using the target keyword to obtain data of an average observed position of the entity; and
mapping the average observed position onto the curve to estimate an average daily spend of the entity.

4. The method of claim 3, further including:
robotically crawling the search engine using the target keyword to obtain data of an observed frequency of appearance of the entity; and
multiplying the estimated average daily spend of the entity with the frequency of appearance to refine the average daily spend figure.

5. A computer readable storage medium, comprising executable instructions to:
query a search engine with a keyword to note an average position of an entity within the search engine results for the keyword;
query a keyword estimate service of the search engine with a plurality of bid prices to establish a relationship between bid price and position; and
map the average position against the relationship to obtain an estimated average daily spend to achieve that average position.

6. The computer readable storage medium of claim 5, further comprising executable instructions to determine a frequency of occurrence of the entity in the search engine results and refine the estimated average daily spend using the determined frequency.

7. An apparatus for deriving advertising expenditure of an entity, comprising:
a lead-generation robot configured to multiply query a search engine using a designated keyword and store in memory a position of an entity appearing within pages resulting from each of said queries;
a keyword estimate service query engine configured to query a keyword estimate service of an Internet search engine using a plurality of bid prices to obtain an estimated position associated with each bid price; and
an advertising expenditure calculator operative to average the position of the entity across all queries by the lead-generation robot for the keyword, establish a relationship between bid price and position using data obtained by the keyword estimate service engine, and determine an estimate of the advertising expenditure of the entity responsive to an association of the average position with the relationship.
